(19) United States
(12) Patent Application Publication
(10) Pub. No.: US 2013/0334787 A1
(43) Pub. Date: Dec. 19, 2013

(54) BICYCLE SEAT WITH ADJUSTABLE STIFFNESS

(71) Applicants: Nicholas Reid Gosseen, Santa Cruz, CA (US); Brendan Pierce, San Jose, CA (US)

(72) Inventors: Nicholas Reid Gosseen, Santa Cruz, CA (US); Brendan Pierce, San Jose, CA (US)

(73) Assignee: SPECIALIZED BICYCLE COMPONENTS, INC., Morgan Hill, CA (US)

(21) Appl. No.: 13/526,101

(22) Filed: Jun. 18, 2012

(51) Int. Cl. B62J 1/10; B62K 3/00

(52) U.S. Cl. 280/200; 297/204; 297/205

(57) ABSTRACT

A bicycle seat including a mount adapted to be coupled to a bicycle frame, a shell supported by the mount, and a tensioned element extending from a first anchor point to a second anchor point. The shell includes a flexible portion for supporting a rider, and the tensioned element includes a support portion providing support to the flexible portion between the first and second anchor points.

### BACKGROUND

The present invention relates generally to bicycles, and more specifically to bicycle seats having an adjustable stiffness.

Bicycles commonly have a seat for supporting the rider. Bicycle seats can be made from a variety of materials, such as leather, plastic, and vinyl. In order to increase the comfort to the rider, bicycle seats are often designed to be resilient. For example, the seat can include foam to allow the seat to conform to the rider. In addition, the seat can be mounted on springs to facilitate absorption of shock loads imparted to the bicycle from the riding surface.

### SUMMARY

The present invention provides a bicycle seat including a mount adapted to be coupled to a bicycle frame, a shell supported by the mount, and a tensioned element (e.g., a flexible element, such as a cable) extending from a first anchor point to a second anchor point. The shell includes a flexible portion for supporting a rider, and the tensioned element includes a support portion providing support to the flexible portion between the first and second anchor points. The bicycle seat can be mounted on a bicycle frame.

In one embodiment, the mount comprises two rails, each rail having a front end secured to a front portion of the shell and a rear end secured to a rear portion of the shell. Preferably, the first anchor point is on the front portion of the shell and the second anchor point is on the rear portion of the shell. In this regard, the flexible portion can be positioned between the front portion and the rear portion.

Tension in the tensioned element is preferably adjustable to thereby adjust the support provided by the tensioned element to the flexible portion. For example, the tensioned element can be wrapped around an adjustment dial for adjusting a tension in the flexible element. A compression member (e.g., two compression members) can be positioned between the tensioned element and the flexible portion (e.g., integrally formed into the shell).

Other aspects of the invention will become apparent by consideration of the detailed description and accompanying drawings.

### BRIEF DESCRIPTION OF THE DRAWINGS

FIG. 1 is a side view of a bicycle including a seat embodying the present invention.

FIG. 2 is an upper perspective view of the seat of FIG. 1.

FIG. 3 is a lower perspective view of the seat of FIG. 1.

FIG. 4 is an exploded perspective view of the seat of FIG. 1 from above the seat.

FIG. 5 is an exploded perspective view of the seat of FIG. 1 from below the seat.

FIG. 6 is a bottom view of the seat of FIG. 1.

FIG. 7 is a section view of the seat taken along line 7-7 in FIG. 6 illustrating the seat in a non-tensioned state.

FIG. 8 is another section view of the seat illustrating the seat in a tensioned state.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

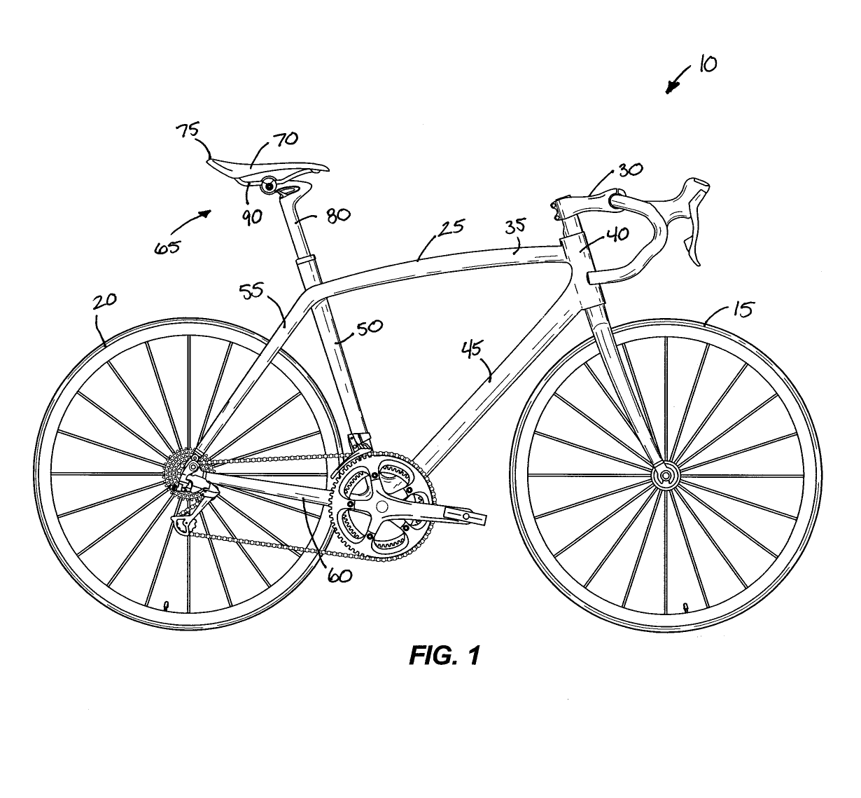

FIG. 1 illustrates a bicycle 10 that includes a front wheel 15, a rear wheel 20, a frame 25, and a steering assembly 30. The frame 25 includes a top tube 35, a head tube 40, a down tube 45, a seat tube 50, seatstays 55, and chainstays 60. A bicycle seat assembly 65 is supported by the frame 25 and provides a surface 70 upon which a rider sits while riding the bicycle 10.

Referring to FIGS. 1-3, the seat assembly includes a bicycle seat 75 that is supported by a seat support 80. The illustrated bicycle seat 75 has a contoured shell 85 (e.g., an injected plastic base) defining the surface 70 for supporting the rider, and a mount that has two lower rails 90 that can be secured to the seat support 80. Each rail 90 extends between a front portion 95 of the shell 85 and a rear portion 100 of the shell 85, and is attached to the respective front and rear portions 95, 100 within rail supports 105 disposed on the underside of the seat 75. The rail support 105 near the front of the seat 75 defines a pocket 110 for supporting both rails 90 near the front portion 95, and each of the two rail supports 105 near the rear of the seat 75 defines a pocket 115 for supporting one of the rails 90 near the rear portion 100.

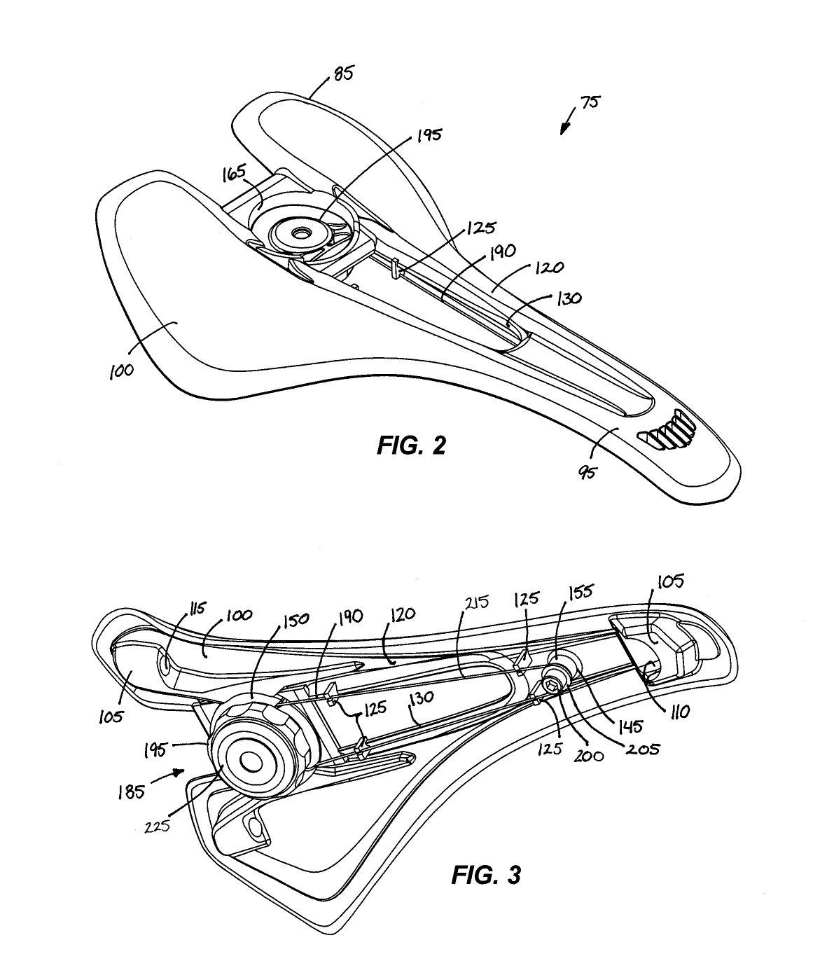

FIGS. 2-8 illustrate the seat assembly 65 without the lower rails 90. The shell 85 includes a flexible portion 120 located between the front and rear portions 95, 100 of the seat 75, and compression members 125 disposed along the underside of the shell 85. As illustrated, the seat 75 has an interior opening 130 located near the center of the shell 85 and bordered by the flexible portion 120 to accommodate the anatomy of a rider, although the seat 75 can be provided without the opening 130. Also, a seat cover (not shown) can be wrapped around the shell 85.

The compression members 125 are disposed along and extend downward from the underside of the shell 85. The illustrated compression members 125 are integrally formed with the shell 85, although the compression members 125 can be provided on the seat 75 as separate elements that are attached to the shell 85. With reference to FIGS. 3, 5, and 6, the shell 85 has four compression members 125 located around the perimeter of the interior opening 130 and engaged with or coupled to the flexible portion 120. Two compression members 125 are located near the forward end of the opening 130 and spaced laterally apart from each other, and two additional compression members 125 are located near the rearward end of the opening 130 and spaced laterally apart from each other.

As illustrated, each compression member 125 takes the form of a protruding tab that has a concavity or notch 135. In some cases, elongated ribs or bars (not shown) can be coupled between the two longitudinally-arranged compression members 125 so that the elongated ribs are positioned along the flexible portion 120. For example, the seat 75 can include laterally opposed elongated ribs that are integrally formed with and extend outward from the underside of the shell 85, or elongated ribs that are separately attached to the shell 85 via the compression members 125. Furthermore, the compression members 125 can take on other forms without deviating from the scope of the invention.

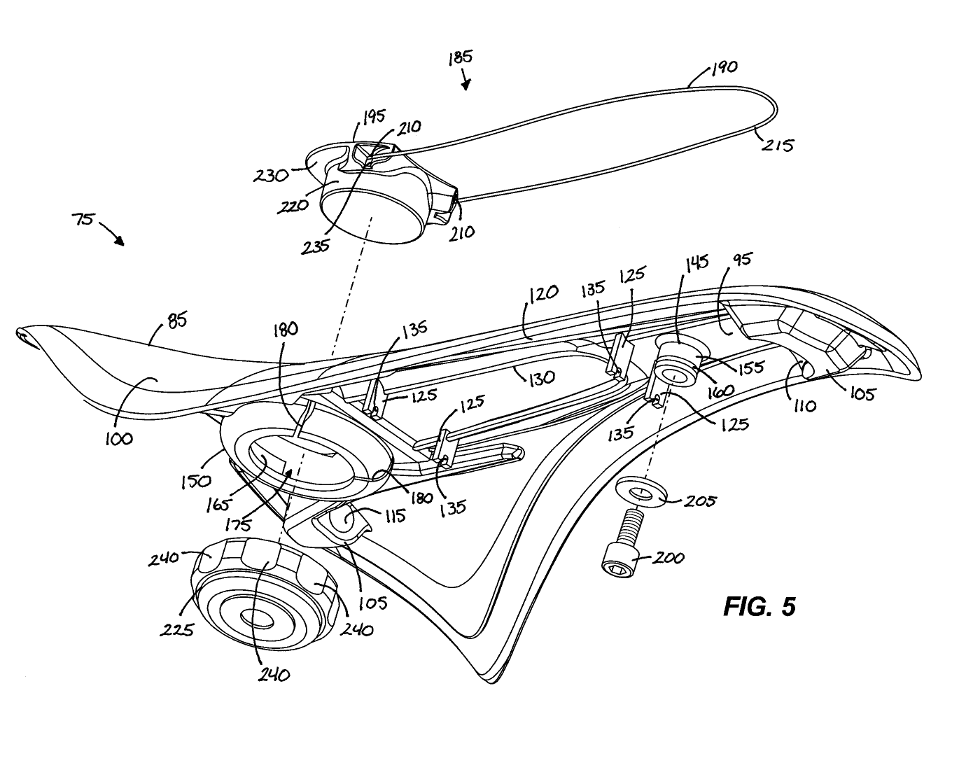

The seat 75 also has a front anchor point 145 located on the front portion 95 and a rear anchor point 150 located on the rear portion 100. In some constructions, one or both of the front anchor point 145 and the rear anchor point 150 can be supported by the rails 90. The front anchor point 145 is located generally rearward of the forwardly-located rail support 105, and is defined by a post 155 that extends outward from an underside of the shell 85. The post 155 can be fastened (bolted, riveted, etc.) to the shell 85, molded into or with the shell 85, or secured to the underside of the shell 85 in other ways. With reference to FIGS. 5, 7, and 8, the front anchor point 145 has an annular channel 160 located inward from a distal end of the post 155.

FIGS. 2-5 show that the rear anchor point 150 is located between and forward of the rearwardly-located rail supports 105. The rear anchor point 150 has a wall 165 defining a recessed cavity 170 and an aperture 175 at the bottom of the cavity 170. The illustrated wall 165 defines a substantially cylindrical cavity 170 (i.e., substantially circular when viewed from above), although the cavity 170 can have other shapes (e.g., polygonal, elliptical, etc.) The rear anchor point 150 also has notches or passageways 180 disposed in the wall 165, although the rear anchor point 150 can be provided without the passageways 180. Also, it should be understood that the front and rear anchor points 145, 150 can be defined by any suitable attachment points on the shell 85 that accommodate a seat tension apparatus that selectively stiffens or relaxes the flexible portion 120.

With reference to FIGS. 2-8, an exemplary seat tension apparatus 185 is coupled to the front and rear anchor points 145, 150. The seat tension apparatus 185 has a tensioned element 190 that extends between the front and rear anchor points 145, 150, and that is adjustable using an adjustment mechanism such as an adjustment dial 195 (see FIGS. 2-8). The illustrated tensioned element 190 is a flexible element such as a cable or wire, although other tensioned elements can be used to support the flexible portion 120. As shown in FIGS. 3 and 5-8, the tensioned element wraps around and is supported on the front anchor point 145 in the annular channel 160. As illustrated, a fastener 200 is attached to the post 155 to secure a washer 205 to the front anchor point 145 so that the tensioned element 190 remains engaged with the post 155 even if the tensioned element 190 is removed from the channel 160 (e.g., due to slack). Alternatively, the front anchor point 145 can be formed with a flange or other device to keep the tensioned element 190 from falling off the post 155. Furthermore, the tensioned element 190 can be coupled to the shell 85 in other ways while still being capable of stiffening and relaxing the flexible portion 120.

For example, the tensioned element 190 can be arranged along the underside of the shell 85 so that the tensioned element 190 makes more than two passes under the flexible portion 120. In these arrangements, the tensioned element can be supported by anchor points (e.g., anchor points 145, 150) on each end and can wrap around or otherwise engage structure on the shell 85 between the anchor points. Other arrangements of the tensioned element 190 along the underside of the shell 85 relative to the flexible portion 120 are also possible and considered herein.

The illustrated tensioned element 190 has opposed ends 210 that are coupled to the adjustment dial 195 and a looped support portion 215 that is located between the ends 210 and engaged with the compression members 125 to support the flexible portion 120 between the front anchor point 145 and the rear anchor point 150. The support portion 215 extends forward from the rear anchor point 150 through the passageways 180, and the compression members 125 are positioned between the support portion 215 and the flexible portion 120 to form a column or pillar that is acted upon by the tensioned element 190 to stiffen or relax the flexible portion 120 based on the tension applied to the tensioned element 190. In other arrangements, the tensioned element 190 can include the compression members 125, or the tensioned element can be engaged with the flexible portion 120 in other ways (e.g., without the compression members 125).

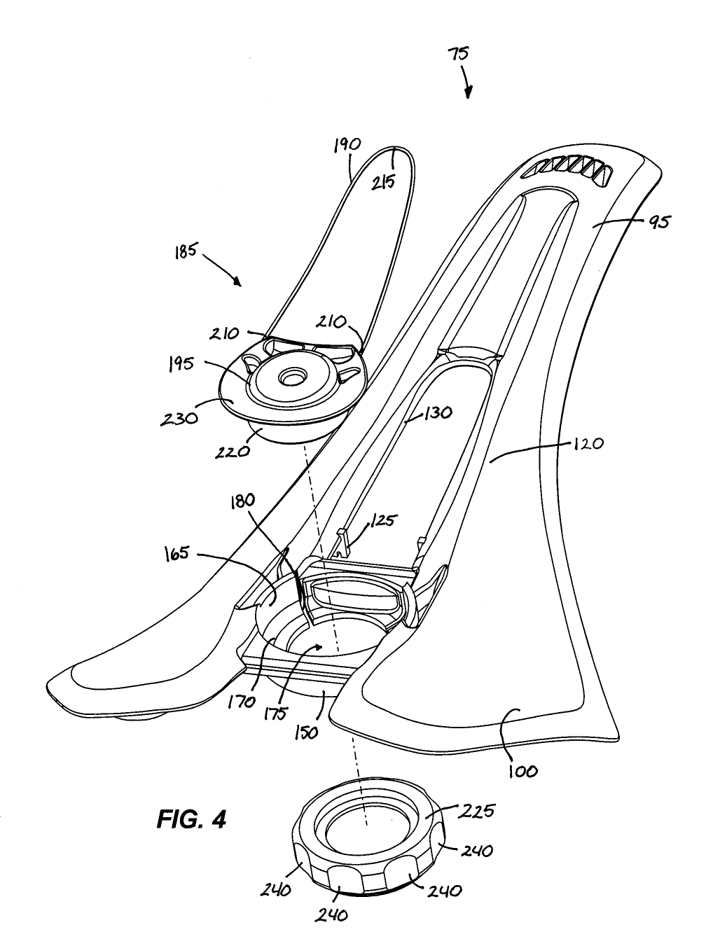

With reference to FIGS. 4 and 5, the adjustment dial 195 has a housing or base 220 and a cap 225 that is rotatably coupled to the base 220 to permit adjustment of the tension on the tensioned element 190. The base 220 is disposed in the recessed cavity 170 and protrudes through the aperture 175. A flanged portion 230 supports the base 220 within the cavity 170. The ends 210 of the tensioned element 190 extend through access openings 235 in the base 220 and are secured to a ratchet or other tension mechanism (not shown) that is housed in the base 220. A cover (not shown) can be placed over the base 220 or to enclose the dial 195 within the cavity 170 (e.g., to protect the dial 195 from the environment). As illustrated, the cap 225 has detents 240 that assist with rotating the cap 225 relative to the base 220.

One such tension apparatus 185 is described and illustrated in detail in U.S. Pat. No. 8,091,182, assigned to Boa Technology, Inc. with its principal place of business in Steamboat Springs, Colorado, and which is incorporated herein by reference. The illustrated adjustment dial 195 of the tension apparatus 185 rotates in one direction (e.g., clockwise) to apply tension the tensioned element 190, and rotates in another direction (e.g., counter-clockwise) to decrease tension on the tensioned element 190. In some constructions of the tension apparatus 185, the adjustment dial 195 can rotate (either clockwise or counter-clockwise) to apply or increase tension on the tensioned element 190, and can include a pushbutton (e.g., a momentary pushbutton or a maintained pushbutton) or another mechanism that is releasable (e.g., movable inward and outward or vertically relative to the base 220) to decrease or release tension on the tensioned element 190. Another adjustment mechanism can include devices that twist, turn, push, pull, ratchet, and/or screw, etc., to increase or decrease the tension on the tensioned element 190. Although only one construction of the tension apparatus 185 is illustrated and only a few examples of tension apparatus are described herein, it will be appreciated that there are several other tension apparatus that can be used to adjust tension on the tensioned element 190.

Moreover, other types of tension apparatus can be utilized to stiffen and relax the flexible portion 120 of the shell 85. One such tension apparatus can include a lever actuator with a lever that is movable in one direction to increase tension to the tensioned element 190, and that is movable in another direction to release tension on the tensioned element 190. Another tension apparatus can include a cam actuator that increase and decrease tension on the tensioned element 190. Yet another tension apparatus can include screw or fastener mechanisms that increase and decrease tension on the tensioned element 190. Still another tension apparatus can include a ratchet mechanism that increases and decrease tensions on the tensioned element 190. Also, certain features of the tension apparatus described herein can be combined to form still other types of tension apparatus (e.g., a lever-cam tension apparatus, a lever-ratchet apparatus, etc.). Other tension apparatus and/or adjustment mechanisms that stiffen and relax the flexible portion 120 are also possible and considered herein.

The illustrated adjustment dial 195 is located at the rear anchor point 150, although the adjustment dial 195 (or another adjustment mechanism) can be located anywhere along the underside of the shell 85 and in communication with the tensioned element 190 (e.g., at the front anchor point 145, between the front and rear anchor points 145, 150, along the side of the shell 85, etc.). With reference to FIGS. 3, 5, and 6, the tensioned element 190 extends continuously from the base 220 generally forward from the rear anchor point 150 longitudinally along the flexible portion 120, wraps around the front anchor point 145, and then extends rearward longitudinally along the flexible portion 120 back to the rear anchor point 150 and the adjustment dial 195. More specifically, the tensioned element 190 extends through one passageway 180 in the rear anchor point 150, extends along one part of the flexible portion 120, wraps around the post 155, extends along another part of the flexible portion 120, and then through the other passageway 180 to the rear anchor point 150. As illustrated, the support portion 215 is engaged with (e.g., nested in or rested upon) the compression members 125 under the flexible portion 125.

The illustrated tension apparatus 185 is assembled onto the seat 75 by orienting the looped tensioned element 190 relative to the rear anchor point 150 so that the support portion 215 extends through the passageways 180. The dial 195 is then placed in the cavity 170 so that the base 220 protrudes through the aperture 175. The support portion 215 is then engaged with the compression members and is routed around the post 155 within the channel 160. The fastener 200 and flange 205, when used, can be attached to the post 155 before or after the tensioned element 190 is wrapped around the post 155. Also, the cap 225 can be attached to the base 220 before or after the tensioned element is routed around the front anchor point.

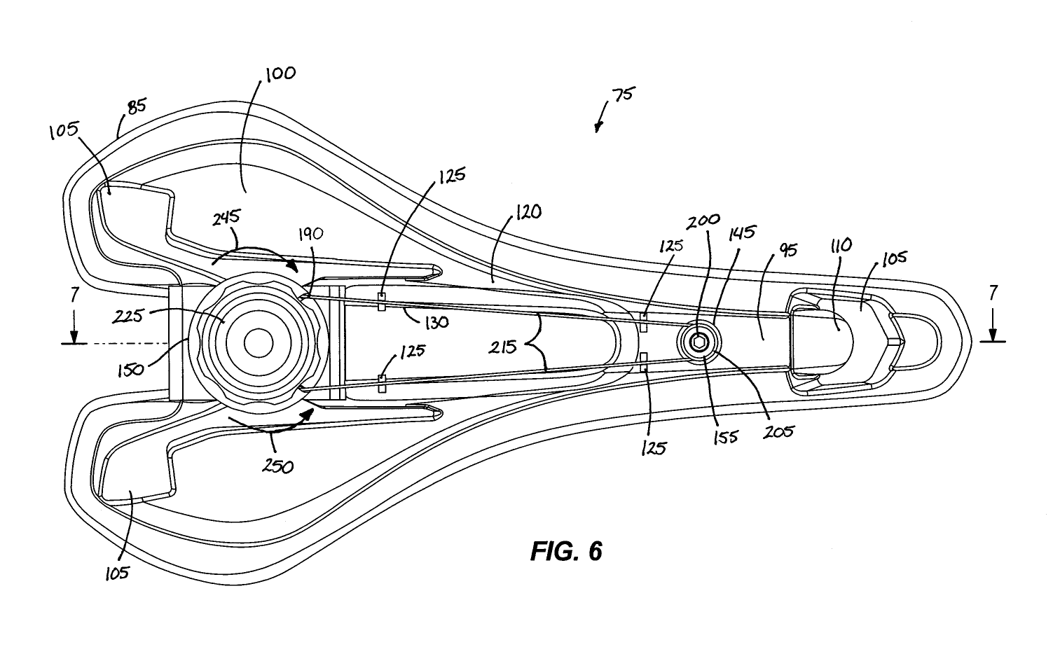

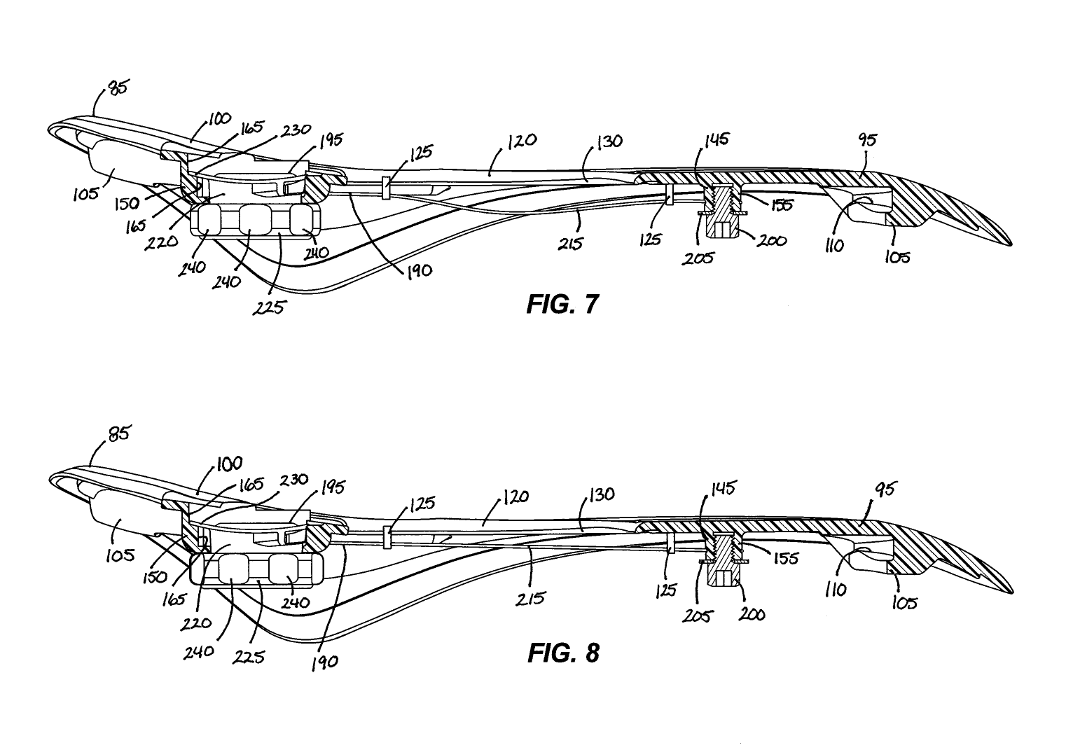

FIG. 7 illustrates the tension apparatus 185 in a non-tensioned state, whereas FIG. 8 illustrates the tension apparatus 185 in a tensioned state. The stiffness of the flexible portion 120 can be adjusted by changing the tension on the tensioned element 190 using the adjustment dial 195. With reference to FIGS. 6-8, when the adjustment dial 195 is rotated in one direction (e.g., clockwise as denoted by arrow 245 in FIG. 6), the tension on the tensioned element 190 increases to provide more support to the flexible portion 120. More specifically, increasing tension on the tensioned element 190 increases the force of the support portion 215 acting on the compression members 125, which in turn increases the pressure or force acting on the flexible portion 120 through the compression members 125 so that the flexible portion 120 becomes more rigid or taut. That is, clockwise rotation of the illustrated adjustment dial 195 stiffens the flexible portion 120 so that the seat 75 provides more support for the rider.

When the adjustment dial 195 is rotated in the other direction (e.g., counter-clockwise as denoted by arrow 250 in FIG. 6), tension on the tensioned element 190 decreases, which in turn provides less support to the flexible portion 120. More specifically, decreasing the tension on the tensioned element 190 reduces the force of the support portion 215 acting on the compression members 125, which in turn decreases the pressure or force acting on the flexible portion 120 through the compression members 125 so that the flexible portion 120 becomes less taut. That is, counter-clockwise rotation of the illustrated adjustment dial 195 softens the feel of the flexible portion 120 so that the seat 75 provides less support for the rider.

As described, the tension in the tensioned element 190 can be incrementally or continuously adjusted using the adjustment dial 195 to increase or decrease the firmness or stiffness (i.e., support) provided by the tensioned element 190 to the flexible portion 120 to provide a desired seat stiffness for the rider. The tensioned element 190 reinforces the flexible portion 120 based on the degree of tension applied to the tensioned element 190 so that the ride characteristics and feel of the seat 75 can be customized to suit different riders. More specifically, the flex of the flexible portion 120 can be tuned using the seat tension apparatus so that the seat 75 can have the same relative stiffness for riders of different weights.

Also, the tension apparatus 185 is arranged on the seat 75 so that a user can engage the cap 225 and adjust seat stiffness before or during a ride. While a rider may prefer a relatively stiff seat 75 for short rides and a relatively soft seat 75 for longer rides, the rider can adjust the stiffness of the seat 75 dynamically during a ride simply by rotating the cap 225 in the appropriate direction. Further, a rider can customize the seat stiffness using the seat tension apparatus 185 based on whether the rider is in an early training phase or late training phase.

Various features and advantages of the invention are set forth in the following claims.

1. A bicycle seat comprising:
a mount adapted to be coupled to a bicycle frame;
a shell supported by the mount and including a flexible portion for supporting a rider; and
a tensioned element extending from a first anchor point to a second anchor point, the tensioned element including a support portion providing support to the flexible portion between the first and second anchor points.

2. A bicycle seat as claimed in claim 1, wherein the mount comprises two rails, each rail having a front end secured to a front portion of the shell and a rear end secured to a rear portion of the shell.

3. A bicycle seat as claimed in claim 2, wherein the first anchor point is on the front portion of the shell and the second anchor point is on the rear portion of the shell.

4. A bicycle seat as claimed in claim 3, wherein the flexible portion is positioned between the front portion and the rear portion.

5. A bicycle seat as claimed in claim 1, wherein a tension in the tensioned element is adjustable to thereby adjust the support provided by the tensioned element to the flexible portion.

6. A bicycle seat as claimed in claim 1, wherein the tensioned element comprises a flexible element.

7. A bicycle seat as claimed in claim 6, further comprising an adjustment dial for adjusting a tension in the flexible element.

8. A bicycle seat as claimed in claim 1, further comprising a compression member positioned between the tensioned element and the flexible portion.

9. A bicycle seat as claimed in claim 8, wherein the compression member is integrally formed into the shell.

10. A bicycle seat as claimed in claim 1, further comprising two compression members positioned between the tensioned member and the flexible portion.

11. A bicycle comprising:
front and rear wheels;
a frame supported by the front and rear wheels; and
a seat for supporting the rider, the seat comprising:
a mount coupled to the frame;
a shell supported by the mount and including a flexible portion for supporting a rider;
a tensioned element extending from a first anchor point to a second anchor point, the tensioned element including a support portion providing support to the flexible portion between the first and second anchor points.

12. A bicycle as claimed in claim 11, wherein the mount comprises two rails, each rail having a front end secured to a front portion of the shell and a rear end secured to a rear portion of the shell.

13. A bicycle as claimed in claim 12, wherein the first anchor point is on the front portion of the shell and the second anchor point is on the rear portion of the shell.

14. A bicycle as claimed in claim 13, wherein the flexible portion is positioned between the front portion and the rear portion.

15. A bicycle as claimed in claim 11, wherein a tension in the tensioned element is adjustable to thereby adjust the support provided by the tensioned element to the flexible portion.

16. A bicycle as claimed in claim 11, wherein the tensioned element comprises a flexible element.

17. A bicycle as claimed in claim 16, wherein the seat further comprises an adjustment dial for adjusting a tension in the flexible element.

18. A bicycle as claimed in claim 11, wherein the seat further comprises a compression member positioned between the tensioned element and the flexible portion.

19. A bicycle as claimed in claim 18, wherein the compression member is integrally formed into the shell.

20. A bicycle as claimed in claim 11, wherein the seat further comprises two compression members positioned between the tensioned member and the flexible portion.
